(19) United States
(12) Patent Application Publication
(10) Pub. No.: US 2026/0323217 A1
(43) Pub. Date: Oct. 15, 2026

(54) METHOD FOR PREPARING FLUX-CONCENTRATING MAGNET, FLUX-CONCENTRATING MAGNET, AND LOUDSPEAKER

(71) Applicant: AAC Microtech (Changzhou) Co., Ltd., Changzhou City (CN)

(72) Inventors: Xiujiang Si, Changzhou (CN); Ronglin Linghu, Changzhou (CN); Bo Xiao, Changzhou (CN)

(21) Appl. No.: 19/342,692

(22) Filed: Sep. 29, 2025

Related U.S. Application Data
(63) Continuation of application No. PCT/CN2025/088843, filed on Apr. 14, 2025.

(51) Int. Cl. H04R 9/02; H01F 41/02; H04R 9/06; H04R 31/00

(52) U.S. Cl. CPC H04R 9/025; H01F 41/0246; H04R 9/06; H04R 31/00; H04R 2209/024

(57) ABSTRACT

A method for preparing a flux-concentrating magnet, a flux-concentrating magnet, and a loudspeaker are provided. The method includes filling alloy powder including magnetic metal in a forming mold, placing an electromagnet on a first side surface of the forming mold with a first magnetic pole of the electromagnet directly facing the first side surface of the forming mold, wherein the electromagnet orients the alloy powder such that the alloy powder exhibits an easy magnetization axis aligned with magnetic field lines of the electromagnet, compressing the alloy powder after orienting to form a green compact, sintering the green compact to form a sintered body, placing the electromagnet on a first side surface of the sintered body for magnetization to obtain a flux-concentrating magnet.

### TECHNICAL FIELD

The present disclosure relates to the field of electronic products, and in particular to a method for preparing a flux-concentrating magnet, a flux-concentrating magnet, and a loudspeaker.

### BACKGROUND

With the advancement of electronic technology, portable consumer electronic devices, such as mobile phones, handheld game consoles, navigation devices, and portable multimedia entertainment devices, have gained increasing popularity. These electronic devices typically employ audio for system feedback, such as call alerts in mobile phones or navigation prompts, which necessitates use of loudspeakers.

Conventional loudspeakers utilize magnets magnetically charged with a uniform magnetic field. As shown in FIG. 1, a magnetization direction is identical across all regions of such magnets. When applied in a magnetic circuit system of a loudspeaker, pole cores are typically provided to concentrate magnetic flux, thereby generating a strong magnetic field in a magnetic gap. However, such structure occupies substantial space in the magnetic circuit system, reducing a volume efficiency of the magnets and limiting magnetic field strength. Additionally, constrained by saturation magnetization of a yoke plate in a pole core, a magnetic circuit exhibits significant magnetic flux leakage.

Therefore, it is necessary to provide a novel technical solution to address above technical problems.

### SUMMARY

To address low magnetic field strength and magnetic flux leakage issues caused by conventional pole-core flux concentration in the related art, in a first aspect, the present disclosure provides a method for preparing a flux-concentrating magnet.

The method for preparing the flux-concentrating magnet includes following steps.

S1: Powder filling: filling alloy powder including magnetic metal in a forming mold.

S2: Orientating: placing at least one electromagnet on a first side surface of the forming mold with a first magnetic pole of the at least one electromagnet directly facing the first side surface of the forming mold, wherein the at least one electromagnet orients the alloy powder such that the alloy powder exhibits an easy magnetization axis aligned with magnetic field lines of the at least one electromagnet.

S3: Compressing: compressing the alloy powder after orienting to form a green compact, in which the green compact includes at least one preset flux-concentrating region corresponding to a first side surface of the at least one electromagnet.

S4: Sintering: sintering the green compact to form a sintered body retaining the at least one preset flux-concentrating region after being sintered.

S5: Magnetizing: placing the at least one electromagnet at a first side surface of the sintered body with the first magnetic pole of the at least one electromagnet directly facing the at least one preset flux-concentrating region after being sintered, and magnetizing the sintered body by the at least one electromagnet to form the flux-concentrating magnet, in which the at least one preset flux-concentrating region after being sintered of the sintered body becomes at least one flux-concentrating region of the flux-concentrating magnet.

Specifically, an average magnetic field strength in the at least one flux-concentrating region is at least three times greater than an average magnetic field strength in other regions on a surface of the flux-concentrating magnet, and the at least one flux-concentrating region is formed on the surface of the flux-concentrating magnet.

As an improvement, the alloy powder is NdFeB alloy powder.

As an improvement, in the S2, two electromagnets are provided and respectively disposed at the first side surface of the forming mold and a second side surface of the forming mold opposite to the first side surface thereof, a first magnetic pole of the first electromagnet directly faces the first side surface of the forming mold, and a second magnetic pole of the second electromagnet directly faces the second side surface of the forming mold; in the S3, the green compact includes two preset flux-concentrating regions, and the two preset flux-concentrating regions include a first preset flux-concentrating region corresponding to the first side surface of the forming mold and a second preset flux-concentrating region corresponding to the second side surface of the forming mold; in the S4, the sintered body formed by sintering the green compact retains the first preset flux-concentrating region after being sintered and the second preset flux-concentrating region after being sintered; in the S5, the two electromagnets are respectively disposed at the first side surface of the sintered body and a second side surface of the sintered body, first magnetic poles of the two electromagnets respectively and directly face the first preset flux-concentrating region after being sintered and the second preset flux-concentrating region after being sintered, and the sintered body is magnetized by the two electromagnets to form the flux-concentrating magnet having two flux-concentrating regions.

As an improvement, in the S2, the two electromagnets are provided and respectively disposed at an upper end and a lower end of the first side surface of the forming mold, the two electromagnets include the first electromagnet and the second electromagnet, the first electromagnet is disposed at the upper end of the first side surface of the forming mold, the second electromagnet is disposed at the lower end of the first side surface of the forming mold, the first magnetic pole of the first electromagnet directly faces the first side surface of the forming mold, and the second magnetic pole of the second electromagnet directly faces the first side surface of the forming mold; in the S3, the green compact includes the two preset flux-concentrating regions, and the two preset flux-concentrating regions include the first preset flux-concentrating region corresponding to an upper portion of the first side surface of the forming mold and the second preset flux-concentrating region corresponding to a lower portion of the first side surface of the forming mold; in the S4, the sintered body formed by sintering the green compact retains the first preset flux-concentrating region after being sintered and the second preset flux-concentrating region after being sintered; in the S5, the first electromagnet and the second electromagnet are respectively disposed at an upper end and a lower end of the first side surface of the sintered body, the first magnetic pole of the first electromagnet directly faces the first side surface of the sintered body, the second magnetic pole of the second electromagnet directly faces a second side surface of the sintered body, and the sintered body is magnetized by the two electromagnets to form the flux-concentrating magnet having two flux-concentrating regions.

As an improvement, in the S1, the forming mold is rectangular and includes two recesses on an upper surface thereof, the two recesses are recessed inward, and the two recesses are symmetrically distributed about a vertical axis passing through a center point of the forming mold; in the S2, the two electromagnets are provided and respectively inserted into the two recesses, each of the two recesses includes two side walls to define four side walls in total, the two side walls of each of the two recesses are opposite to each other, magnetic poles of each of the two electromagnets respectively and directly face top portions of the two side walls of a corresponding one of the two recesses, and polarities of spatially opposed magnetic poles in magnetic poles of the two electromagnets are the same; in the S3, the green compact includes two green compact recesses and four green compact side walls, the two green compact recesses have the same dimensions as the two recesses of the forming mold, each of the four green compact side walls corresponds to a corresponding one of the four side walls of the two recesses of the forming mold and has the same dimension as the corresponding one of the four side walls of the two recesses of the forming mold, top portions of the four green compact side walls of the green compact respectively correspond to the two electromagnets, and the four green compact side walls of the green compact respectively include four preset flux-concentrating regions at the top portions thereof; in the S4, the sintered body formed by sintering the green compact retains the two green compact recesses after being sintered and the four preset flux-concentrating regions after being sintered; and in the S5, the two electromagnets are respectively disposed in the two green compact recesses of the sintered body, the magnetic poles of the two electromagnets respectively and directly face the four preset flux-concentrating regions, and the sintered body is magnetized by the two electromagnets to form the flux-concentrating magnet having four flux-concentrating regions.

In a second aspect, the present disclosure provides a flux-concentrating magnet, the flux-concentrating magnet includes at least one flux-concentrating region on an outer surface thereof and different magnetization directions within an interior thereof. The different magnetization directions are all converged toward the at least one flux-concentrating region. An average magnetic field strength in the at least one flux-concentrating region is at least three times greater than an average magnetic field strength in other regions on a surface of the flux-concentrating magnet, and the at least one flux-concentrating region is formed on the surface of the flux-concentrating magnet.

In a third aspect, the present disclosure provides a first embodiment of a loudspeaker, including a vibration system and a magnetic circuit system. The magnetic circuit system is configured to drive the vibration system to generate sound. The vibration system includes a vibrating diaphragm and a voice coil, and the voice coil is configured to drive the vibrating diaphragm to vibrate. The magnetic circuit system includes a magnet assembly, the magnet assembly includes at least one first magnetic portion and at least one second magnetic portion, and a magnetic gap is formed between the at least one first magnetic portion and the at least one second magnetic portion. At least one of the at least one first magnetic portion and the at least one second magnetic portion is the flux-concentrating magnet as foregoing. The magnetic circuit system includes a magnetic field concentrating region in the magnetic gap, the at least one flux-concentrating region of the flux-concentrating magnet forms the magnetic field concentrating region corresponding to the magnetic gap. An average magnetic field strength in the magnetic field concentrating region is at least three times greater than an average magnetic field strength in non-concentrated regions of the magnetic gap. The voice coil is disposed in the magnetic field concentrating region.

As an improvement, the magnetic circuit system further includes a lower clamping plate, and the lower clamping plate is fixed to one side of the magnet assembly away from the vibrating diaphragm.

As an improvement, both the at least one first magnetic portion and the at least one second magnetic portion are flux-concentrating magnets, the at least one first magnetic portion and the at least one second magnetic portion include side walls forming the magnetic gap, and the magnetic field concentrating region is located at top portions or mid-portions of the side walls of the at least one first magnetic portion and the at least one second magnetic portion.

As an improvement, the magnetic field concentrating region is located at the top portions of the side walls of the at least one first magnetic portion and the at least one second magnetic portion, the at least one second magnetic portion includes a notch at the magnetic field concentrating region, the magnetic circuit system further includes a first magnetic flux conducting component disposed at the notch of the at least one second magnetic portion.

As an improvement, the at least one first magnetic portion is the flux-concentrating magnet, and a magnetization direction of the at least one second magnetic portion is parallel to a vibration direction of the loudspeaker. The magnetic circuit system further includes the first magnetic flux conducting component attached to a surface of the at least one second magnetic portion. The first magnetic flux conducting component is disposed corresponding to the magnetic field concentrating region.

As an improvement, the at least one second magnetic portion is the flux-concentrating magnet, and a magnetization direction of the at least one first magnetic portion is parallel to the vibration direction of the loudspeaker. The magnetic circuit system further includes a second magnetic flux conducting component attached to a surface of the at least one first magnetic portion. The second magnetic flux conducting component is disposed corresponding to the magnetic field concentrating region.

As an improvement, both the at least one first magnetic portion and the at least one second magnetic portion are the flux-concentrating magnets. The at least one first magnetic portion and the at least one second magnetic portion include the side walls forming the magnetic gap. The magnetic field concentrating region is located at the top portions of the side walls of the at least one first magnetic portion and the at least one second magnetic portion. The magnetic circuit system further includes at least one third magnetic flux conducting component disposed at bottom portions of the side walls of the at least one first magnetic portion and the at least one second magnetic portion.

As an improvement, both the at least one first magnetic portion and the at least one second magnetic portion are the flux-concentrating magnets. The at least one first magnetic portion and the at least one second magnetic portion includes the side walls forming the magnetic gap. The magnetic field concentrating region is located at the top portions of the side walls of the at least one first magnetic portion and the at least one second magnetic portion. The magnetic circuit system further includes at least one auxiliary magnet disposed at the bottom portions of the side walls of the at least one first magnetic portion and the at least one second magnetic portion. A magnetization direction of the at least one auxiliary magnet in perpendicular to the vibration direction of the loudspeaker.

In a fourth aspect, the present disclosure provides a second embodiment of the loudspeaker, including the vibration system and the magnetic circuit system. The magnetic circuit system is configured to drive the vibration system to generate sound. the vibration system includes the vibrating diaphragm and the voice coil, and the voice coil is configured to drive the vibrating diaphragm to vibrate. The magnetic circuit system includes a first portion and a second portion, and the magnetic gap is formed between the first portion and the second portion. The first portion and the second portion include side walls forming the magnetic gap. The magnetic circuit system further includes a third portion, the third portion is configured to connect the first portion and the second portion, and the third portion is disposed at bottom portions of the side walls of the first portion and the second portion. The first portion, the second portion, and the third portion are integrally formed as a single magnet, and the single magnet is the flux-concentrating magnet as foregoing. The at least one flux-concentrating region of the flux-concentrating magnet is located at top portions of the side walls of the first portion and the second portion, the magnetic circuit system includes the magnetic field concentrating region in the magnetic gap, and the at least one flux-concentrating region forms the magnetic field concentrating region corresponding to the magnetic gap. The average magnetic field strength in the magnetic field concentrating region is at least three times greater than the average magnetic field strength in the non-concentrated regions of the magnetic gap. The voice coil is disposed in the magnetic field concentrating region.

Compared with the related art, the loudspeaker according to the present disclosure employs the magnet assembly in which different regions are magnetized in different directions. Different magnetization directions in the magnet assembly are converged toward the magnetic field concentrating region in the magnetic gap. As a result, the magnet assembly itself generates a flux-concentrating effect, eliminating need for a pole core. Such configuration enables generation of a stronger magnetic field strength in the magnetic field concentrating region, thereby enhancing a driving force on the voice coil and improving a response frequency of the vibrating diaphragm. Consequently, sensitivity of the loudspeaker is increased. Moreover, the magnetic flux leakage is reduced, and miniaturization of the loudspeaker is further facilitated.

### BRIEF DESCRIPTION OF DRAWINGS

FIG. 1 is a schematic diagram illustrating a method for preparing a magnet in the related art.

FIG. 2 is a flowchart illustrating a method for preparing a flux-concentrating magnet according to the present disclosure.

FIG. 3 is a schematic diagram illustrating a first embodiment of the method for preparing the flux-concentrating magnet according to the present disclosure.

FIG. 4 is a schematic diagram illustrating a second embodiment of the method for preparing the flux-concentrating magnet according to the present disclosure.

FIG. 5 is a schematic diagram illustrating a third embodiment of the method for preparing the flux-concentrating magnet according to the present disclosure.

FIG. 6 is a schematic diagram illustrating a fourth embodiment of the method for preparing the flux-concentrating magnet according to the present disclosure.

FIG. 7 is a three-dimensional schematic diagram of a loudspeaker of the present disclosure.

FIG. 8 is a cross-sectional schematic diagram taken along line A-A shown in FIG. 7.

FIG. 9 is a three-dimensional exploded schematic diagram of the loudspeaker shown in FIG. 7.

FIG. 10 is a cross-sectional schematic diagram of a magnetic circuit system and a voice coil in a first embodiment of the loudspeaker according to the present disclosure.

FIG. 11 is a cross-sectional schematic diagram of the magnetic circuit system and the voice coil in a second embodiment of the loudspeaker according to the present disclosure.

FIG. 12 is a cross-sectional schematic diagram of the magnetic circuit system and the voice coil in a third embodiment of the loudspeaker according to the present disclosure.

FIG. 13 is a cross-sectional schematic diagram of the magnetic circuit system and the voice coil in a fourth embodiment of the loudspeaker according to the present disclosure.

FIG. 14 is a cross-sectional schematic diagram of the magnetic circuit system and the voice coil in a fifth embodiment of the loudspeaker according to the present disclosure.

FIG. 15 is a cross-sectional schematic diagram of the magnetic circuit system and the voice coil in a sixth embodiment of the loudspeaker according to the present disclosure.

FIG. 16 is a cross-sectional schematic diagram of the magnetic circuit system and the voice coil in a seventh embodiment of the loudspeaker according to the present disclosure.

FIG. 17 is a cross-sectional schematic diagram of the magnetic circuit system and the voice coil in an eighth embodiment of the loudspeaker according to the present disclosure.

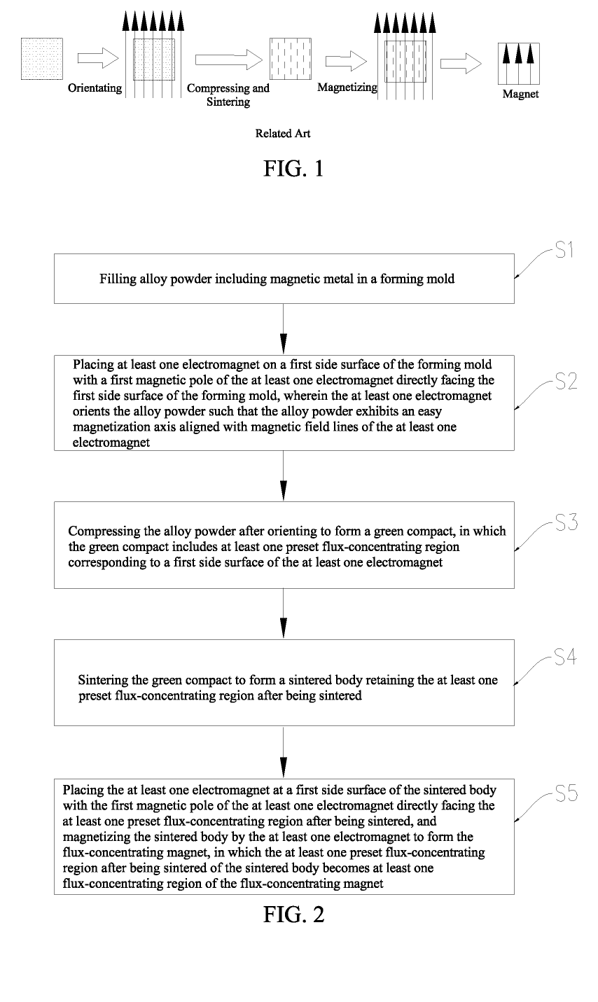

Reference numerals in the drawings: 100. loudspeaker; 11. frame; 20. vibration system; 21. vibrating diaphragm; 22. voice coil; 23. framework; 24. flexible circuit board; 30. magnetic circuit system; 31. magnet assembly 32. first magnetic portion; 33. second magnetic portion; 34. magnetic gap; 341. magnetic field concentrating region; 35. lower clamping plate; 36. first magnetic flux conducting component; 37. second magnetic flux conducting component; 38. at least one third magnetic flux conducting component; 39. auxiliary magnet; 40. single magnet.

### DETAILED DESCRIPTION OF EMBODIMENTS

Following description of the present disclosure is made in conjunction with accompanying drawings and embodiments.

It should be noted that terms "first", "second", etc., as used in the specification and claims of the present disclosure and in the accompanying drawings, are employed to distinguish between similar objects and are not intended to imply a specific sequence or temporal order. It should be understood that such terms may be interchanged under appropriate circumstances so that embodiments of the present disclosure described herein may be practiced in sequences different from those illustrated or described. Furthermore, terms "comprise", "include", "have", and any variations thereof, are intended to be construed as non-exclusive inclusions, meaning that stated elements or features are included, but other elements or features may also be present.

In conventional magnet manufacturing, orientation and magnetization processes employ a uniform magnetic field with a single, fixed direction. In contrast, a flux-concentrating magnet of the present disclosure utilizes a curved magnetic field that converges toward a specific region. Such curved magnetic field may be generated by at least one electromagnet. Depending on different desired types of magnets, a magnetic field from a specific region of the at least one electromagnet, or a combined field produced by different electromagnets, may be selectively used.

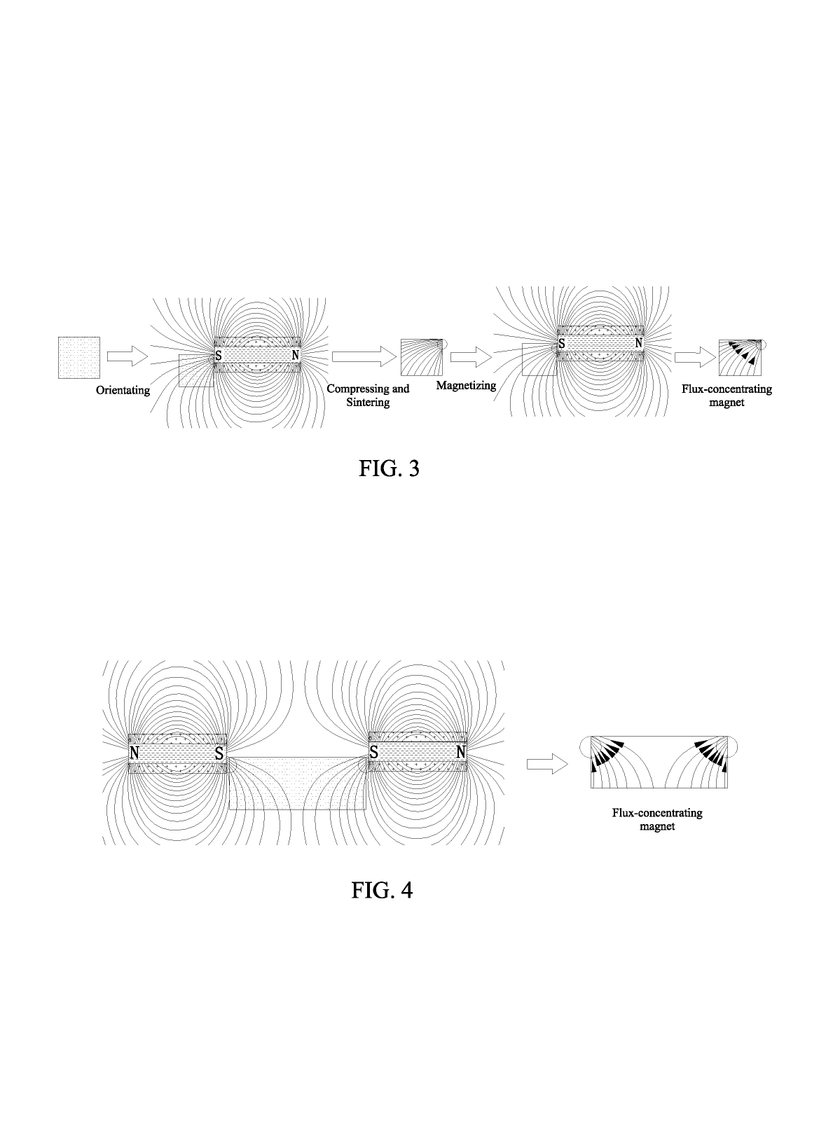

Please refer to FIGS. 2-6, the present disclosure provides a method for preparing the flux-concentrating magnet, including following steps.

S1: Powder filling: Cleaning and melting alloy raw material including magnetic metal to obtain an alloy, performing hydrogen decrepitation and jet milling on the alloy to obtain alloy powder, and filling the alloy powder in a forming mold.

S2: Orientating: placing at least one electromagnet on a first side surface of the forming mold with a first magnetic pole of the at least one electromagnet directly facing the first side surface of the forming mold, in which the at least one electromagnet orients the alloy powder such that the alloy powder exhibits an easy magnetization axis aligned with magnetic field lines of the at least one electromagnet.

S3: Compressing: placing the alloy power after orienting in a forming press, compressing the alloy powder after orienting to form a green compact, in which the green compact includes at least one preset flux-concentrating region (indicated by dashed circles in the drawings) corresponding to a first side surface of the at least one electromagnet.

S4: Sintering: sintering the green compact in a sintering furnace to form a sintered body retaining the at least one preset flux-concentrating region after being sintered.

S5: Magnetizing: placing the at least one electromagnet at a first side surface of the sintered body with the first magnetic pole of the at least one electromagnet directly facing the at least one preset flux-concentrating region after being sintered, and magnetizing the sintered body by the at least one electromagnet to form the flux-concentrating magnet, in which the at least one preset flux-concentrating region after being sintered of the sintered body becomes at least one flux-concentrating region of the flux-concentrating magnet.

In the above steps, the first magnetic pole of the at least one electromagnet is a south pole (S) while the second magnetic pole of the at least one electromagnet is a north pole (N); alternatively, the first magnetic pole of the at least one electromagnet is the N pole and the second magnetic pole of the at least one electromagnet is the S pole.

Specifically, in the flux-concentrating magnet obtained by processing the above steps, an average magnetic field strength in the at least one flux-concentrating region is at least three times greater than an average magnetic field strength in other regions on a surface of the flux-concentrating magnet, and the at least one flux-concentrating region is formed on the surface of the flux-concentrating magnet.

As an improvement, the alloy powder is NdFeB alloy powder.

As an improvement, depending on specific application requirements, orientation and magnetization of the flux-concentrating magnet are achieved as illustrated in FIG. 4, in the S2, two electromagnets are provided and respectively disposed at the first side surface of the forming mold and a second side surface of the forming mold opposite to the first side surface thereof, a first magnetic pole of the first electromagnet directly faces the first side surface of the forming mold, and a second magnetic pole of the second electromagnet directly faces the second side surface of the forming mold; in the S3, the green compact includes two preset flux-concentrating regions, and the two preset flux-concentrating regions include a first preset flux-concentrating region corresponding to the first side surface of the forming mold and a second preset flux-concentrating region corresponding to the second side surface of the forming mold; in the S4, the sintered body formed by sintering the green compact retains the first preset flux-concentrating region after being sintered and the second preset flux-concentrating region after being sintered; in the S5, the two electromagnets are respectively disposed at the first side surface of the sintered body and a second side surface of the sintered body, first magnetic poles of the two electromagnets respectively and directly face the first preset flux-concentrating region after being sintered and the second preset flux-concentrating region after being sintered, and the sintered body is magnetized by the two electromagnets to form the flux-concentrating magnet having two flux-concentrating regions.

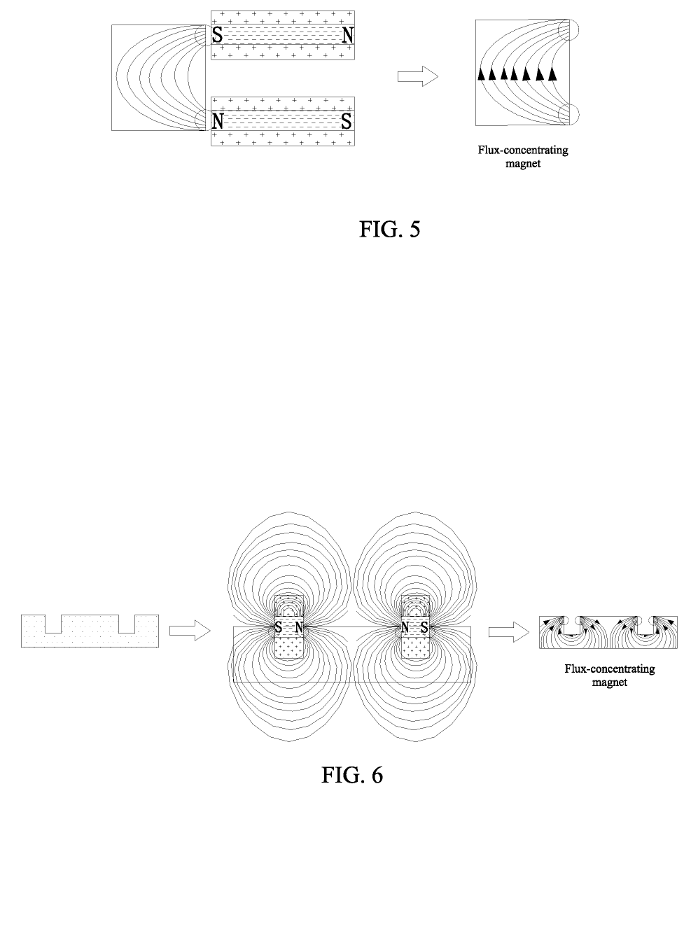

As an improvement, depending on the specific application requirements, the orientation and the magnetization of the flux-concentrating magnet are achieved as illustrated in FIG. 5, in the S2, the two electromagnets are provided and respectively disposed at an upper end and a lower end of the first side surface of the forming mold, the two electromagnets include the first electromagnet and the second electromagnet, the first electromagnet is disposed at the upper end of the first side surface of the forming mold, the second electromagnet is disposed at the lower end of the first side surface of the forming mold, the first magnetic pole of the first electromagnet directly faces the first side surface of the forming mold, and the second magnetic pole of the second electromagnet directly faces the first side surface of the forming mold; in the S3, the green compact includes the two preset flu-concentrating regions, and the two preset flu-concentrating regions include the first preset flux-concentrating region corresponding to an upper portion of the first side surface of the forming mold and the second preset flux-concentrating region corresponding to a lower portion of the first side surface of the forming mold; in the S4, the sintered body formed by sintering the green compact retains the first preset flux-concentrating region after being sintered and the second preset flux-concentrating region after being sintered; in the S5, the first electromagnet and the second electromagnet are respectively disposed at an upper end and a lower end of the first side surface of the sintered body, the first magnetic pole of the first electromagnet directly faces the first side surface of the sintered body, the second magnetic pole of the second electromagnet directly faces a second side surface of the sintered body, and the sintered body is magnetized by the two electromagnets to form the flux-concentrating magnet having two flux-concentrating regions.

As an improvement, depending on the specific application requirements, the orientation and the magnetization of the flux-concentrating magnet are achieved as illustrated in FIG. 6, in the S1, the forming mold is rectangular and includes two recesses on an upper surface thereof, the two recesses are recessed inward, and the two recesses are symmetrically distributed about a vertical axis passing through a center point of the forming mold; in the S2, the two electromagnets are provided and respectively inserted into the two recesses, each of the two recesses includes two side walls to define four side walls in total, the two side walls of each of the two recesses are opposite to each other, magnetic poles of each of the two electromagnets respectively and directly face top portions of the two side walls of a corresponding one of the two recesses, and polarities of spatially opposed magnetic poles in magnetic poles of the two electromagnets are the same; in the S3, the green compact includes two green compact recesses and four green compact side walls, the two green compact recesses have the same dimensions as the two recesses of the forming mold, each of the four green compact side walls corresponds to a corresponding one of the four side walls of the two recesses of the forming mold and has the same dimension as the corresponding one of the four side walls of the two recesses of the forming mold, top portions of the four green compact side walls of the green compact respectively correspond to the two electromagnets, and the four green compact side walls of the green compact respectively include four preset flux-concentrating regions at the top portions thereof; in the S4, the sintered body formed by sintering the green compact retains the two green compact recesses after being sintered and the four preset flux-concentrating regions after being sintered; and in the S5, the two electromagnets are respectively disposed in the two green compact recesses of the sintered body, the magnetic poles of the two electromagnets respectively and directly face the four preset flux-concentrating regions, and the sintered body is magnetized by the two electromagnets to form the flux-concentrating magnet having four flux-concentrating regions.

Additionally, the present disclosure provides a flux-concentrating magnet, the flux-concentrating magnet includes at least one flux-concentrating region on an outer surface thereof and different magnetization directions within an interior thereof. The different magnetization directions are all converged toward the at least one flux-concentrating region. An average magnetic field strength in the at least one flux-concentrating region is at least three times greater than an average magnetic field strength in other regions on a surface of the flux-concentrating magnet, and the at least one flux-concentrating region is formed on the surface of the flux-concentrating magnet.

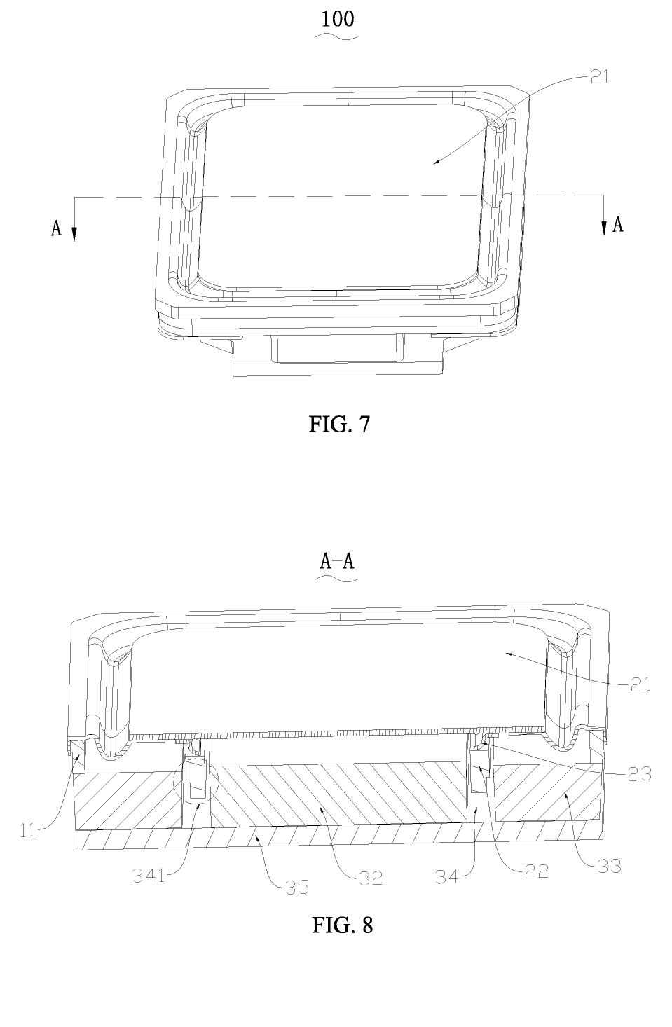

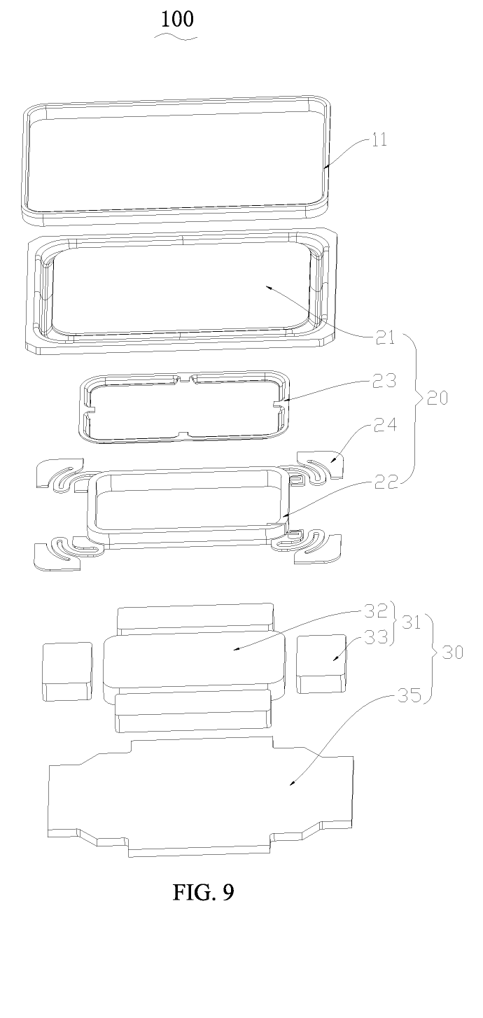

As shown in FIGS. 7-16, the present disclosure provides a first embodiment of a loudspeaker 100, including a vibration system 20 and a magnetic circuit system 30. The magnetic circuit system 30 is configured to drive the vibration system 20 to generate sound. The vibration system 20 includes a vibrating diaphragm 21, a flexible circuit board 24, a voice coil 22, and a framework 23. The vibrating diaphragm 21 is fixed to a frame 11, the flexible circuit board 24 is spaced apart from the vibrating diaphragm 21, the voice coil 22 is electrically connected to the flexible circuit board 24 and configured to drive the vibrating diaphragm 21 to vibrate, and the framework 23 is fixed to the vibrating diaphragm 21 and configured to support the voice coil 22.

The magnetic circuit system 30 includes a magnet assembly 31, the magnet assembly 31 includes at least one first magnetic portion 32 and at least one second magnetic portion 33, and a magnetic gap 34 is formed between the at least one first magnetic portion 32 and the at least one second magnetic portion 33. At least one of the at least one first magnetic portion 32 and the at least one second magnetic portion 33 is the flux-concentrating magnet as foregoing. The magnetic circuit system 30 includes a magnetic field concentrating region 341 in the magnetic gap 34, the at least one flux-concentrating region of the flux-concentrating magnet forms the magnetic field concentrating region 341 corresponding to the magnetic gap 34. An average magnetic field strength in the magnetic field concentrating region 341 is at least three times greater than an average magnetic field strength in non-concentrated regions of the magnetic gap 34. The voice coil 22 is disposed in the magnetic field concentrating region 341.

In an initial state of the loudspeaker 100, the voice coil 22 is disposed in the magnetic field concentrating region 341. In this configuration, the voice coil 22 is capable of rapid response. At least one of the at least one first magnetic portion 32 and the at least one second magnetic portion 33 are magnetized to be the flux-concentrating magnet, the flux-concentrating magnet includes different magnetization directions within the interior thereof, the different magnetization directions are all converged toward the magnetic field concentrating region 341, thereby generating an enhanced magnetic field strength in the magnetic field concentrating region 341. The magnetic field concentrating region 341 interacts with the voice coil 22 after being energized, resulting in increased driving force on the voice coil 22, improving a response frequency of the vibrating diaphragm 21, and consequently enhancing the sensitivity of the loudspeaker 100. Furthermore, such structure of the loudspeaker 100 allows for omission of at least a portion of a pole core, which reduces magnetic flux leakage and facilitates miniaturization of the loudspeaker 100.

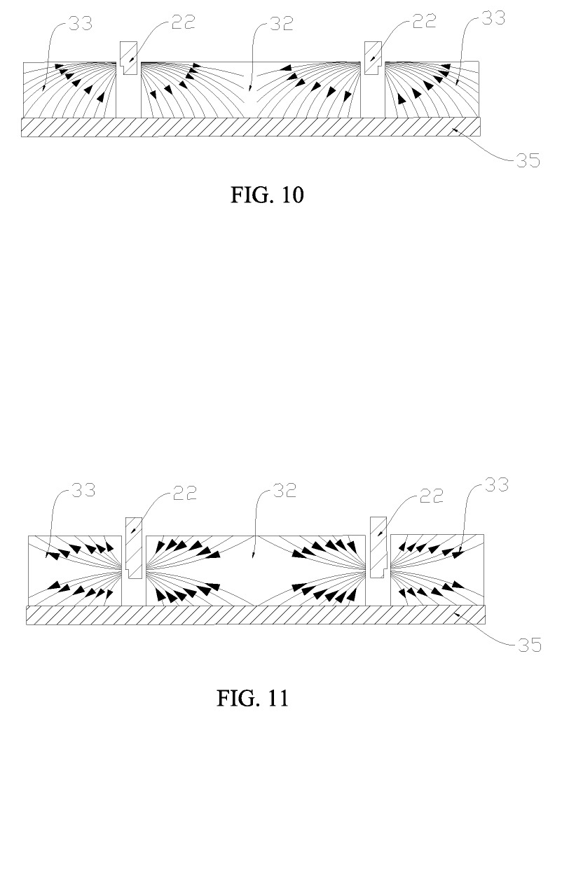

Furthermore, please refer to FIGS. 10-14, in which arrows indicate magnetization directions of the magnet assembly 31. The magnetization directions of the magnet assembly 31 extend from an N pole to an S pole, or from the S pole to the N pole. The magnetic circuit system 30 further includes a lower clamping plate 35, and the lower clamping plate 35 is fixed to one side of the magnet assembly 31 away from the vibrating diaphragm 21.

Specifically, please refer to FIGS. 10-11, in which assembly states of the magnetic circuit system 30 and the voice coil 22 according to the present disclosure are illustrated. Both the at least one first magnetic portion 32 and the at least one second magnetic portion 33 are flux-concentrating magnets, the at least one first magnetic portion 32 and the at least one second magnetic portion 33 include side walls forming the magnetic gap 34, and the magnetic field concentrating region 341 is located at top portions or mid-portions of the side walls of the at least one first magnetic portion 32 and the at least one second magnetic portion 33. Such structure of the loudspeaker 100 allows for omission of the pole core, thereby increasing volumes of the first magnetic portion 32 and the second magnetic portion 33, enhancing a magnetic field strength in the magnetic field concentrating region 341, increasing a driving force on the voice coil 22, and further enhancing the sensitivity of the loudspeaker 100.

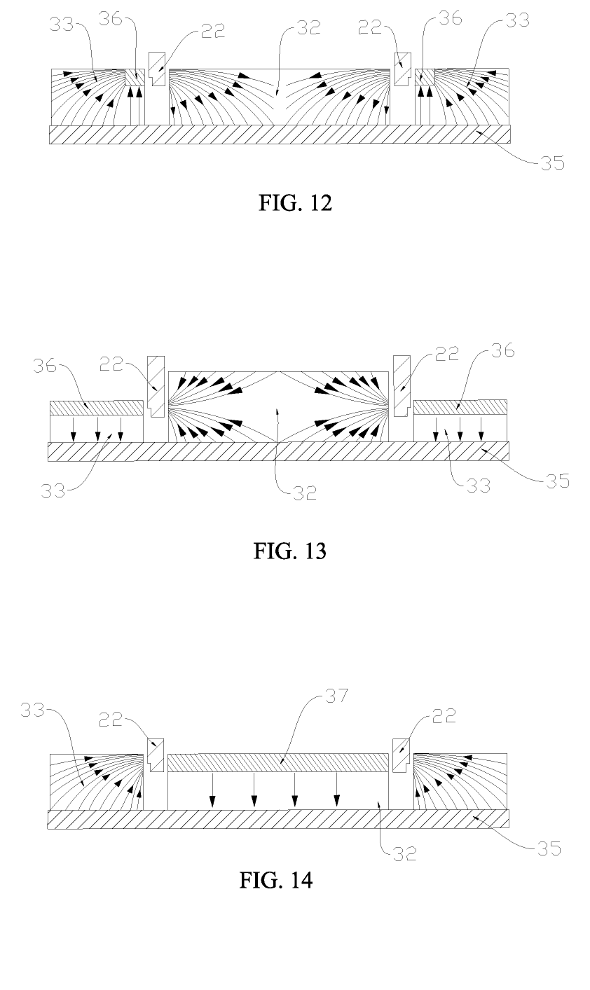

As an improvement, please refer to FIG. 12, the magnetic field concentrating region 341 is located at the top portions of the side walls of the at least one first magnetic portion 32 and the at least one second magnetic portion 33, the at least one second magnetic portion 33 includes a notch at the magnetic field concentrating region, the magnetic circuit system 30 further includes a first magnetic flux conducting component 36 disposed at the notch of the at least one second magnetic portion 33.

As an improvement, please refer to FIG. 13, the at least one first magnetic portion 32 is the flux-concentrating magnet, and a magnetization direction of the at least one second magnetic portion 33 is parallel to a vibration direction of the loudspeaker 100. The magnetic circuit system 30 further includes the first magnetic flux conducting component 36 attached to a surface of the at least one second magnetic portion 33. The first magnetic flux conducting component 36 is disposed corresponding to the magnetic field concentrating region 341.

As an improvement, please refer to FIG. 14, the at least one second magnetic portion 33 is the flux-concentrating magnet, and a magnetization direction of the at least one first magnetic portion 32 is parallel to the vibration direction of the loudspeaker 100. The magnetic circuit system 30 further includes a second magnetic flux conducting component 37 attached to a surface of the at least one first magnetic portion 32. The second magnetic flux conducting component 37 is disposed corresponding to the magnetic field concentrating region 341.

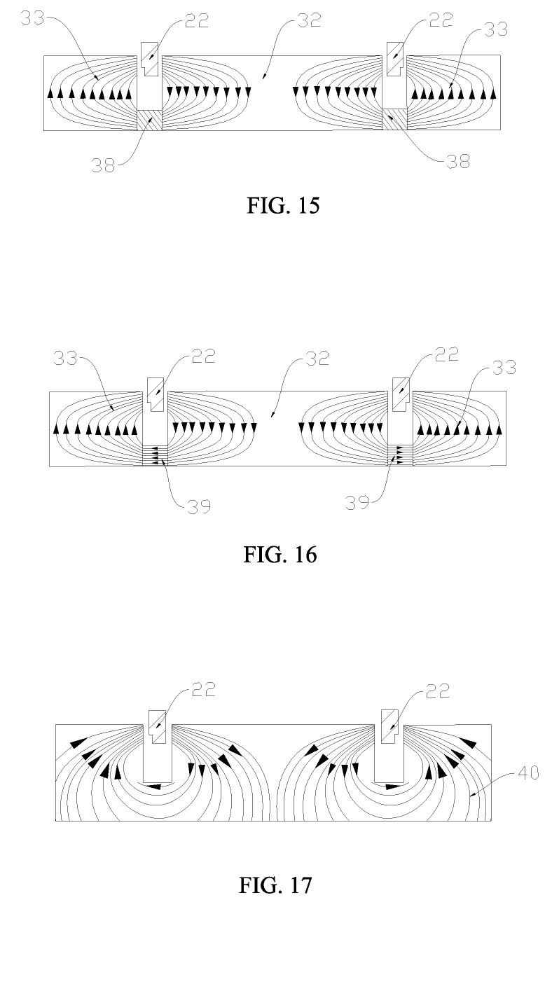

As an improvement, the loudspeaker 100 according to the present disclosure omits the lower clamping plate 35, please refer to FIGS. 15-16, both the at least one first magnetic portion 32 and the at least one second magnetic portion 33 are the flux-concentrating magnets. The at least one first magnetic portion 32 and the at least one second magnetic portion 33 include the side walls forming the magnetic gap 34. The magnetic field concentrating region 341 is located at the top portions of the side walls of the at least one first magnetic portion 32 and the at least one second magnetic portion 33. The magnetic circuit system 30 further includes at least one third magnetic flux conducting component 38 disposed at bottom portions of the side walls of the at least one first magnetic portion 32 and the at least one second magnetic portion 33. The at least one third magnetic flux conducting component 38 is configured to connect the at least one first magnetic portion 32 and the at least one second magnetic portion 33, which effectively replaces the lower clamping plate 35 and further increases a volume of the magnet assembly 31.

Alternatively, both the at least one first magnetic portion 32 and the at least one second magnetic portion 33 are the flux-concentrating magnets. The at least one first magnetic portion 32 and the at least one second magnetic portion 33 includes the side walls forming the magnetic gap 34. The magnetic field concentrating region 341 is located at the top portions of the side walls of the at least one first magnetic portion 32 and the at least one second magnetic portion 33. The magnetic circuit system 30 further includes at least one auxiliary magnet 39 disposed at the bottom portions of the side walls of the at least one first magnetic portion 32 and the at least one second magnetic portion 33. A magnetization direction of the at least one auxiliary magnet 39 in perpendicular to the vibration direction of the loudspeaker 100. The at least one auxiliary magnet 39 is configured to connect the at least one first magnetic portion 32 and the at least one second magnetic portion 33, which effectively replaces the lower clamping plate 35 and further increases the volume of the magnet assembly 31.

As an improvement, the present disclosure provides a second embodiment of the loudspeaker 100, in structural departure from the first embodiment of the loudspeaker 100, the second embodiment of the loudspeaker 100 incorporates a single magnet 40 in the magnetic circuit system 30. Specifically, please refer to FIG. 17, the loudspeaker according to the second embodiment of the present disclosure, the magnetic circuit system 30 includes a first portion and a second portion, and the magnetic gap 34 is formed between the first portion and the second portion. The first portion and the second portion include side walls forming the magnetic gap 34. The magnetic circuit system 30 further includes a third portion, the third portion is configured to connect the first portion and the second portion, and the third portion is disposed at bottom portions of the side walls of the first portion and the second portion. The first portion, the second portion, and the third portion are integrally formed as a single magnet 40, and the single magnet 40 is the flux-concentrating magnet as foregoing. The at least one flux-concentrating region of the flux-concentrating magnet is located at top portions of the side walls of the first portion and the second portion, the magnetic circuit system 30 includes the magnetic field concentrating region 341 in the magnetic gap 34, and the at least one flux-concentrating region forms the magnetic field concentrating region 341 corresponding to the magnetic gap 34. The average magnetic field strength in the magnetic field concentrating region 341 is at least three times greater than the average magnetic field strength in the non-concentrated regions of the magnetic gap 34. The voice coil 22 is disposed in the magnetic field concentrating region 341. Such structure of the magnetic circuit system 30 eliminates need for any magnetizable material in a magnetic circuit. The magnetic circuit consists of a single large magnet with different magnetization directions provided therein, enabling a flux-concentrating effect that generates peak horizontal magnetic field strength at the magnetic gap 34.

The loudspeaker 100 according to the present disclosure employs the magnet assembly 31 in which different regions are magnetized in different directions. Different magnetization directions in the magnet assembly 31 are converged toward the magnetic field concentrating region 341 in the magnetic gap 34. As a result, the magnet assembly 31 itself generates the flux-concentrating effect, eliminating the need for the pole core. Such configuration enables generation of a stronger magnetic field strength in the magnetic field concentrating region 341, thereby enhancing the driving force on the voice coil 22 and improving the response frequency of the vibrating diaphragm 21. Consequently, the sensitivity of the loudspeaker 100 is increased. Moreover, the magnetic flux leakage is reduced, and the miniaturization of the loudspeaker 100 is further facilitated.

The foregoing are merely embodiments of the present disclosure. It should be noted that, for those who skilled in the art, various modifications and improvements may be made without departing from a spirit and scope of the present disclosure. All such modifications fall within a protection scope of the present disclosure.

What is claimed is:

1. A method for preparing a flux-concentrating magnet, comprising:
S1: filling alloy powder comprising magnetic metal in a forming mold;
S2: placing at least one electromagnet on a first side surface of the forming mold with a first magnetic pole of the at least one electromagnet directly facing the first side surface of the forming mold, wherein the at least one electromagnet orients the alloy powder such that the alloy powder exhibits an easy magnetization axis aligned with magnetic field lines of the at least one electromagnet;
S3: compressing the alloy powder after orienting to form a green compact, wherein the green compact comprises at least one preset flux-concentrating region corresponding to a first side surface of the at least one electromagnet;
S4: sintering the green compact to form a sintered body retaining the at least one preset flux-concentrating region after being sintered; and
S5: placing the at least one electromagnet at a first side surface of the sintered body with the first magnetic pole of the at least one electromagnet directly facing the at least one preset flux-concentrating region after being sintered, and magnetizing the sintered body by the at least one electromagnet to form the flux-concentrating magnet, wherein the at least one preset flux-concentrating region after being sintered of the sintered body becomes at least one flux-concentrating region of the flux-concentrating magnet;
wherein an average magnetic field strength in the at least one flux-concentrating region is at least three times greater than an average magnetic field strength in other regions on a surface of the flux-concentrating magnet, and the at least one flux-concentrating region is formed on the surface of the flux-concentrating magnet.

2. The method for preparing the flux-concentrating magnet according to claim 1, wherein the alloy powder is NdFeB alloy powder.

3. The method for preparing the flux-concentrating magnet according to claim 1, wherein in the S2, two electromagnets are provided and respectively disposed at the first side surface of the forming mold and a second side surface of the forming mold opposite to the first side surface thereof, a first magnetic pole of the first electromagnet directly faces the first side surface of the forming mold, and a second magnetic pole of the second electromagnet directly faces the second side surface of the forming mold;
in the S3, the green compact comprises two preset flux-concentrating regions, and the two preset flux-concentrating regions comprise a first preset flux-concentrating region corresponding to the first side surface of the forming mold and a second preset flux-concentrating region corresponding to the second side surface of the forming mold;
in the S4, the sintered body formed by sintering the green compact retains the first preset flux-concentrating region after being sintered and the second preset flux-concentrating region after being sintered; and
in the S5, the two electromagnets are respectively disposed at the first side surface of the sintered body and a second side surface of the sintered body, first magnetic poles of the two electromagnets respectively and directly face the first preset flux-concentrating region after being sintered and the second preset flux-concentrating region after being sintered, and the sintered body is magnetized by the two electromagnets to form the flux-concentrating magnet having two flux-concentrating regions.

4. The method for preparing the flux-concentrating magnet according to claim 1, wherein in the S2, two electromagnets are provided and respectively disposed at an upper end and a lower end of the first side surface of the forming mold, the two electromagnets comprise a first electromagnet and a second electromagnet, the first electromagnet is disposed at the upper end of the first side surface of the forming mold, the second electromagnet is disposed at the lower end of the first side surface of the forming mold, a first magnetic pole of the first electromagnet directly faces the first side surface of the forming mold, and a second magnetic pole of the second electromagnet directly faces the first side surface of the forming mold;
in the S3, the green compact comprises two preset flux-concentrating regions, and the two preset flux-concentrating regions comprise a first preset flux-concentrating region corresponding to an upper portion of the first side surface of the forming mold and a second preset flux-concentrating region corresponding to a lower portion of the first side surface of the forming mold;
in the S4, the sintered body formed by sintering the green compact retains the first preset flux-concentrating region after being sintered and the second preset flux-concentrating region after being sintered; and
in the S5, the first electromagnet and the second electromagnet are respectively disposed at an upper end and a lower end of the first side surface of the sintered body, the first magnetic pole of the first electromagnet directly faces the first side surface of the sintered body, the second magnetic pole of the second electromagnet directly faces a second side surface of the sintered body, and the sintered body is magnetized by the two electromagnets to form the flux-concentrating magnet having two flux-concentrating regions.

5. The method for preparing the flux-concentrating magnet according to claim 1, wherein in the S1, the forming mold is rectangular and comprises two recesses on an upper surface thereof, the two recesses are recessed inward, and the two recesses are symmetrically distributed about a vertical axis passing through a center point of the forming mold;
in the S2, two electromagnets are provided and respectively inserted into the two recesses, each of the two recesses comprises two side walls to define four side walls in total, the two side walls of each of the two recesses, the two side walls of each of the two recesses are opposite to each other, magnetic poles of each of the two electromagnets respectively and directly face top portions of the two side walls of a corresponding one of the two recesses, and polarities of spatially opposed magnetic poles in magnetic poles of the two electromagnets are the same;
in the S3, the green compact comprises two green compact recesses and four green compact side walls, the two green compact recesses have the same dimensions as the two recesses of the forming mold, each of the four green compact side walls corresponds to a corresponding one of the four side walls of the two recesses of the forming mold and has the same dimension as the corresponding one of the four side walls of the two recesses of the forming mold, top portions of the four green compact side walls of the green compact respectively correspond to the two electromagnets, and the four green compact side walls of the green compact respectively comprise four preset flux-concentrating regions at the top portions thereof;
in the S4, the sintered body formed by sintering the green compact retains the two green compact recesses after being sintered and the four preset flux-concentrating regions after being sintered; and
in the S5, the two electromagnets are respectively disposed in the two green compact recesses of the sintered body, the magnetic poles of the two electromagnets respectively and directly face the four preset flux-concentrating regions after being sintered, and the sintered body is magnetized by the two electromagnets to form the flux-concentrating magnet having four flux-concentrating regions.

6. A loudspeaker, comprising:
a vibration system; and
a magnetic circuit system;
wherein the magnetic circuit system is configured to drive the vibration system to generate sound;
the vibration system comprises a vibrating diaphragm and a voice coil, and the voice coil is configured to drive the vibrating diaphragm to vibrate;
the magnetic circuit system comprises a magnet assembly, the magnet assembly comprises at least one first magnetic portion and at least one second magnetic portion, and a magnetic gap is formed between the at least one first magnetic portion and the at least one second magnetic portion;
at least one of the first magnetic portion and the second magnetic portion is the flux-concentrating magnet prepared by the preparation method according to claim 1; the flux-concentrating magnet, comprising:
at least one flux-concentrating region on an outer surface thereof; and
different magnetization directions within an interior thereof;
wherein the different magnetization directions are all converged toward the at least one flux-concentrating region; and
an average magnetic field strength in the at least one flux-concentrating region is at least three times greater than an average magnetic field strength in other regions on a surface of the flux-concentrating magnet, and the at least one flux-concentrating region is formed on the surface of the flux-concentrating magnet;

7. The method for preparing the flux-concentrating magnet according to claim 6, wherein the magnetic circuit system further comprises a lower clamping plate, and the lower clamping plate is fixed to one side of the magnet assembly away from the vibrating diaphragm.

8. The loudspeaker according to claim 7, wherein both the at least one first magnetic portion and the at least one second magnetic portion are flux-concentrating magnets;
the at least one first magnetic portion and the at least one second magnetic portion comprise side walls forming the magnetic gap; and
the magnetic field concentrating region is located at top portions or mid-portions of the side walls of the at least one first magnetic portion and the at least one second magnetic portion.

9. The method for preparing the flux-concentrating magnet according to claim 8, wherein the magnetic field concentrating region is located at the top portions of the side walls of the at least one first magnetic portion and the at least one second magnetic portion;
the at least one second magnetic portion comprises a notch at the magnetic field concentrating region; and
the magnetic circuit system further comprises a first magnetic flux conducting component disposed at the notch of the at least one second magnetic portion.

10. The loudspeaker according to claim 7, wherein the at least one first magnetic portion is the flux-concentrating magnet, and a magnetization direction of the at least one second magnetic portion is parallel to a vibration direction of the loudspeaker;
the magnetic circuit system further comprises a first magnetic flux conducting component attached to a surface of the at least one second magnetic portion; and
the first magnetic flux conducting component is disposed corresponding to the magnetic field concentrating region.

11. The loudspeaker according to claim 7, wherein the at least one second magnetic portion is the flux-concentrating magnet, and a magnetization direction of the at least one first magnetic portion is parallel to a vibration direction of the loudspeaker;
the magnetic circuit system further comprises a second magnetic flux conducting component attached to a surface of the at least one first magnetic portion; and
the second magnetic flux conducting component is disposed corresponding to the magnetic field concentrating region.

12. The loudspeaker according to claim 6, wherein both the at least one first magnetic portion and the at least one second magnetic portion are flux-concentrating magnets;
the at least one first magnetic portion and the at least one second magnetic portion comprise side walls forming the magnetic gap;
the magnetic field concentrating region is located at top portions of the side walls of the at least one first magnetic portion and the at least one second magnetic portion; and
the magnetic circuit system further comprises at least one third magnetic flux conducting component disposed at bottom portions of the side walls of the at least one first magnetic portion and the at least one second magnetic portion.

13. The loudspeaker according to claim 6, wherein both the at least one first magnetic portion and the at least one second magnetic portion are flux-concentrating magnets;
the at least one first magnetic portion and the at least one second magnetic portion comprise side walls forming the magnetic gap;
the magnetic field concentrating region is located at top portions of the side walls of the at least one first magnetic portion and the at least one second magnetic portion;
the magnetic circuit system further comprises at least one auxiliary magnet disposed at bottom portions of the side walls of the at least one first magnetic portion and the at least one second magnetic portion; and
a magnetization direction of the at least one auxiliary magnet in perpendicular to a vibration direction of the loudspeaker.

14. A loudspeaker, comprising:
a vibration system; and
a magnetic circuit system;
wherein the magnetic circuit system is configured to drive the vibration system to generate sound;
the vibration system comprises a vibrating diaphragm and a voice coil, and the voice coil is configured to drive the vibrating diaphragm to vibrate;
the magnetic circuit system comprises a first portion and a second portion, and a magnetic gap is formed between the first portion and the second portion;
the first portion and the second portion comprise side walls forming the magnetic gap;
the magnetic circuit system further comprises a third portion, the third portion is configured to connect the first portion and the second portion, and the third portion is disposed at bottom portions of the side walls of the first portion and the second portion;
the first portion, the second portion, and the third portion are integrally formed as a single magnet, and the single magnet is the flux-concentrating magnet prepared by the preparation method according to claim 1; the flux-concentrating magnet, comprising:
at least one flux-concentrating region on an outer surface thereof; and
different magnetization directions within an interior thereof;
wherein the different magnetization directions are all converged toward the at least one flux-concentrating region; and
an average magnetic field strength in the at least one flux-concentrating region is at least three times greater than an average magnetic field strength in other regions on a surface of the flux-concentrating magnet, and the at least one flux-concentrating region is formed on the surface of the flux-concentrating magnet;
